(19) United States
(12) Patent Application Publication
(10) Pub. No.: US 2014/0278464 A1
(43) Pub. Date: Sep. 18, 2014

(54) SYSTEMS AND METHODS FOR MANAGING ONLINE MULTI-SESSION INTERVIEWS

(71) Applicant: CREATIVE MARKETING PROGRAMS, Kansas City, MO (US)

(72) Inventors: Barbara Davis, Raymore, MO (US); Gregg Glass, Bonner Springs, MO (US); Russ Lownie, Kansas City, MO (US); Hal Hutcheson, Liberty, MO (US); Joe Schultz, Kansas City, MO (US); Dwight Orr, Parkville, MO (US)

(73) Assignee: Creative Marketing Programs, Kansas City, MO (US)

(21) Appl. No.: 13/836,596

(22) Filed: Mar. 15, 2013

(51) Int. Cl. G06F 19/00

(52) U.S. Cl. CPC G06F 19/3418
USPC 705/2

(57) ABSTRACT

A method for managing a plurality of scheduled online interviews between a user and a plurality of professionals is provided. The method includes initiating a first online interview between the user and a first professional at a first predefined time, and once a first predetermined period of time has elapsed from the first predefined time, terminating the first online interview. The method further includes determining if a second professional is available to conduct a second online interview with the user, and based on the determining that the second professional is not available to conduct the second online interview with the user, replacing the second professional with a third professional that is available to conduct the second online interview with the user at a second predefined time, and initiating the second online interview between the user and the third professional at the second predefined time.

### BACKGROUND

The field of the disclosure relates generally to online interviews, and more specifically, to managing online multi-session interviews.

When individuals find themselves in need of medical care, they often have a difficult time finding a physician that they will be satisfied with. Many individuals select their physicians based on: a referral from a primary care physician; a recommendation from a friend or relative; or a healthcare provider directory. For example, an individual might go to a healthcare provider's website and search for a physician based on a specialty and/or a geographic area. However, quite often, individuals end up selecting a physician who does not have the optimal specialty for their specific medical condition.

In order to assist individuals in selecting a doctor, some companies have created specialized services to help in the selection process. However, these specialized services typically only provide a directory that identifies physicians based on simple criteria, such as practice area and geographic location. Further, these types of searches do not take into consideration whether or not a physician and a prospective patient are a good fit for one another. Thus, quite often, individuals end up selecting physicians they are not completely satisfied with.

One of the best known ways to determine whether or not a physician and a potential patient might be a good fit, is an in-person interview between the physician and the potential patient. However, there are several drawbacks in conducting in-person interviews one at a time: 1) these interviews are very time consuming for both the physician and the potential patient; 2) scheduling these interviews during a time period that works for both the physician and the potential patient can be very difficult; and 3) a time frame between interviewing the physician and another potential physician can be so great that one's memory can become faded, and thus, direct comparisons between the physicians can be difficult. For example, it can be difficult to directly compare one physician's response to a given question to another physician's response to the same question due to a disjoint in time nature between each interview.

### BRIEF DESCRIPTION

In one aspect, a method for managing a plurality of scheduled online interviews between a user and a plurality of professionals is provided. The method includes initiating a first online interview between the user and a first professional at a first predefined time, once a first predetermined period of time has elapsed from the first predefined time, terminating the first online interview, determining if a second professional is available to conduct a second online interview with the user, the second online interview scheduled to be initiated at a second predefined time, the second predefined time being at an end of the first predefined period of time that elapsed from the first predefined time, based on the determining that the second professional is not available to conduct the second online interview with the user, replacing the second professional with a third professional that is available to conduct the second online interview with the user at the second predefined time, and initiating the second online interview between the user and the third professional at the second predefined time.

In another aspect, a method for managing a plurality of scheduled online interviews between a plurality of users and a plurality of professionals is provided. The method includes initiating a first online interview between a first user and a first professional at a first predefined time, initiating a second online interview between a second user and a second professional at the first predefined time, once a first predetermined period of time has elapsed from the first predefined time, terminating the first online interview and the second online interview, initiating a third online interview between the first user and the second professional at a second predefined time, initiating a fourth online interview between the second user and the first professional at the second predefined time, the second predefined time being at an end of the first predefined period of time that elapsed from the first predefined time, and generating a report based on the first online interview, the second online interview, the third online interview, and the fourth online interview.

In yet another aspect, one or more non-transitory computer-readable media having computer-executable instructions embodied thereon, wherein when executed by at least one processor, the computer-executable instructions cause the processor to initiate a first online interview between a user and a first professional at a first predefined time, once a first predetermined period of time has elapsed from the first predefined time, terminate the first online interview, determine if a second professional is available to conduct a second online interview with the user, the second online interview scheduled to be initiated at a second predefined time, the second predefined time being at an end of the first predefined period of time that elapsed from the first predefined time, based on the determining that the second professional is not available to conduct the second online interview with the user, replace the second professional with a third professional that is available to conduct the second online interview with the user at the second predefined time, and initiate the second online interview between the user and the third professional at the second predefined time.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a block diagram of an exemplary system for managing online multi-session interviews.

FIG. 2 is a block diagram of an exemplary server.

FIG. 3 is a flowchart of an exemplary method for managing online multi-session interviews.

### DETAILED DESCRIPTION

While embodiments of the present disclosure are directed to managing online multi-session interviews between physicians and potential patients, one of ordinary skill in the art guided by the teachings herein will appreciate that the scope of the present disclosure is not limited to managing online multi-session interviews between physicians and potential patients. Rather, embodiments described herein may include managing online multi-session interviews between a user and, for example, dentists, architects, attorneys, accountants, engineers, or any other profession that provides a service are also within the scope of the present disclosure.

Choosing a physician is often compared to choosing a significant other. That is, a physician should be someone a patient is comfortable communicating with, someone the patient has a certain level of chemistry with, and someone the patient feels they can trust. Thus, while some factors, such as geographic location, practice area, years of experience, and whether or not a physician is covered under a particular health insurance can each be determined from a physician's biography, other factors can only be determined from actually interviewing the physician.

Further, finding particular physicians to interview can be a daunting task in and of itself, let alone finding an interview time that works both for you and each of the physicians. However, the present disclosure provides a system and method that matches a user/potential patient with a plurality of physicians and enables the user/potential patient to interview each of the plurality of physicians one after the other in an online setting.

With reference to FIG. 1, a block diagram of an exemplary system 100 for managing multi-session online interviews between a plurality of physicians and a potential patient is provided. Exemplary embodiments are implemented using a first computing device 102 that is in communication with one more additional computing devices 104 and a server 106 through a network 108. One of ordinary skill in the art guided by the teachings herein will appreciate that system 100 may include any number of computing devices greater than two. Further, aspects of the disclosure are operable with any computing device that performs the functionality illustrated and described herein, or its equivalent. For example, embodiments of the disclosure are operable with a desktop, a laptop, an embedded device, a personal digital assistant, a mobile telephone, and other portable and non-portable computing devices capable of performing the functionality illustrated and described herein.

Computing device 102 and one or more computing devices 104 include a memory area 110, at least one processor 112, a display 114, a video capture device 116, and an audio device 118. Although processor 112 is shown separate from memory area 110 in computing device 102 and in one or more computing devices 104, embodiments of the disclosure contemplate that memory area 110 may be onboard processor 112 such as in some embedded systems.

In one embodiment, display 114 may be, for example, a capacitive touch screen display that is integrated into computing device 102 and one or more computing devices 104 or external to computing device 102 and one or more computing devices 104. User input functionality may be provided in display 114 which acts as a user input selection device. For example, display 114 may be configured to be responsive to a user pressing contact on display 114 to selectively perform functionality. Further, display 114 may provide presentation capabilities related to, for example, text, images, audio, video, graphics, alerts, and the like. As such, display 114 presents information ranging from low-resolution to high-resolution multimedia.

With reference now to FIG. 2, a block diagram of an exemplary server 106 is provided. In the exemplary embodiment, server 106 includes communications fabric 202 that provides communications between a processor unit 204, a memory 206, persistent storage 208, a communications unit 210, and an input/output (I/O) unit 212.

Processor unit 204 executes instructions for software that may be loaded into a storage device (e.g., memory 206). Processor unit 204 may be a set of one or more processors or may include multiple processor cores, depending on the particular implementation. Further, processor unit 204 may be implemented using one or more heterogeneous processor systems in which a main processor is present with secondary processors on a single chip. In another embodiment, processor unit 204 may be a homogeneous processor system containing multiple processors of the same type.

Memory 206 and persistent storage 208 are examples of storage devices. As used herein, a storage device is any tangible piece of hardware that is capable of storing information either on a temporary basis and/or a permanent basis. Memory 206 may be, for example, without limitation, a random access memory and/or any other suitable volatile or non-volatile storage device. Persistent storage 208 may take various forms depending on the particular implementation, and persistent storage 208 may contain one or more components or devices. For example, persistent storage 208 may be a hard drive, a flash memory, a rewritable optical disk, a rewritable magnetic tape, and/or some combination of the above. The media used by persistent storage 208 also may be removable. For example, without limitation, a removable hard drive may be used for persistent storage 208.

A storage device, such as memory 206 and/or persistent storage 208, may be configured to store data for use with the processes described herein. For example, a storage device may store (e.g., have embodied thereon) computer-executable instructions, executable software components and/or any other information suitable for use with the methods described herein. When executed by a processor (e.g., processor unit 204), such computer-executable instructions and/or components cause processor unit 204 to perform one or more of the operations described herein. Exemplary data that may be stored in memory 206 and/or persistent storage 208 is a medical profile of a user/patient.

In addition, a profile of each a plurality of physicians may also be stored in memory 206 and/or persistent storage 208. Each profile may include a geographic location of a physician, a practice area for the physician, a healthcare plan for the physician, a healthcare provider organization for the physician, a time indicator that indicates when the physician is available, a new-patient indicator indicating if the physician is accepting new patients, a satisfaction rating for the physician, an amenities rating for the physician, a transportation rating for the physician, a dispute rating for the physician, a recency rating for the physician, a procedure cost for the physician, an experience rating for the physician, a race of the physician, an age of the physician, a sex of the physician, and a religious affiliation of the physician. However, while a medical profile of a user and physician profiles are described as being stored in memory 206, a medical profile of a user and physician profiles may be stored and accessed from a memory area remote from server 106. For example, a medical profile of a user and physician profiles may be stored in a cloud service, a database, or other memory area accessible by server 106. Such embodiments reduce the computational and storage burden on server 106.

Communications unit 210, in these examples, provides for communications with other computing devices or systems, for example, computing device 102 and one or more computing devices 104. In the exemplary embodiment, communications unit 210 is a network interface card. Communications unit 210 may provide communications through the use of either or both physical and wireless communication links.

Input/output unit 212 enables input and output of data with other devices that may be connected to server 106. For example, without limitation, input/output unit 212 may provide a connection for user input through a user input device, such as a keyboard and/or a mouse. Further, input/output unit 212 may send output to a printer.

Instructions for the operating system and applications or programs are located on persistent storage 208. These instructions may be loaded into memory 206 for execution by processor unit 204. The processes of the different embodiments may be performed by processor unit 204 using computer implemented instructions and/or computer-executable instructions, which may be located in a memory, such as memory 206. These instructions are referred to herein as program code (e.g., object code and/or source code) that may be read and executed by a processor in processor unit 204. The program code in the different embodiments may be embodied on different physical or tangible computer-readable media, such as memory 206 or persistent storage 208.

Program code 216 is located in a functional form on non-transitory computer-readable media 218 that is selectively removable and may be loaded onto or transferred to server 106 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to server 106. The tangible form of computer-readable media 218 is also referred to as computer recordable storage media. In some instances, computer-readable media 218 may not be removable.

Alternatively, program code 216 may be transferred to server 106 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

In some illustrative embodiments, program code 216 may be downloaded over network 108 to persistent storage 208 from another computing device or computer system for use within server 106. For instance, program code stored in a computer-readable storage medium in an additional server (not shown) may be downloaded over network 108 from the additional server to server 106. The additional server providing program code 216 in this example may be a server computer, a workstation, a client computer, or some other device capable of storing and transmitting program code 216.

Program code 216 may be organized into computer-executable components that are functionally related. For example, program code 216 may include one or more part agents, ordering manager agents, supplier agents, and/or any component suitable for practicing the methods described herein. Each component may include computer-executable instructions that, when executed by processor unit 204, cause processor unit 204 to perform one or more of the operations described herein.

The different components illustrated herein for server 106 are not meant to provide architectural limitations to the manner in which different embodiments may be implemented. The different illustrative embodiments may be implemented in a computer system including components in addition to or in place of those illustrated for server 106.

In another example, a bus system may be used to implement communications fabric 202 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 106 or a cache such as that found in an interface and memory controller hub that may be present in communications fabric 202.

Referring now to FIG. 3, an exemplary flow chart illustrates a process for managing online multi-session interviews between a user (e.g., a prospective client/patient) and a plurality of physicians. At 302, a user is matched with a plurality of pre-qualified physicians to interview. One of ordinary skill in the art guided by the teachings herein will appreciate that matching a user with a plurality of pre-qualified physicians may be as simple as matching the user with the only pre-qualified physicians that are available during a particular time slot the user has selected to conduct the online interviews, or as complicated as implementing matching algorithms based on physician selection criteria for the user, a medical profile of the user, physician profiles, and the like.

For example, a physician selection criteria for a user may be received from the user at computing device 102 and stored in memory 206 at server 106. Server 106 also accesses a plurality of physician profiles from memory 206. Server 106 may receive profile information directly from each physician, as well other information from a third party, such as malpractice information, insurance claim information, and feedback from previous patients.

Server 106 may rank each physician profile based on the physician selection criteria received from the user and conditions within the medical profile of the user. For example, the physician selection criteria may include a request that a prospective physician be within a particular geographic location, has performed a particular procedure, is ranked above a particular threshold, and an order of customer satisfaction. An additional request in the physician selection criteria may be to exclude a particular gender of physicians. Once a filtered list of matched physicians is generated, server 106 may then facilitate scheduling interview appointments for each of the physicians in the filtered list as well as the user.

At 304, the user and each physician matched to the user are provided with a scheduled time for conducting a set of online interviews. As mentioned above, the scheduled times may simply be based on a time a particular online interview event is being conducted by a third party, or the scheduled times may be scheduled by server 106 based on a known availability of the user and the matched physicians. Either way, each interview is scheduled to be conducted within a particular period of time. For example, five interviews with five physicians, within a total time of fifty minutes. Thus, if an initial interview is scheduled for a particular time “A”, then each of the following interviews may be scheduled in 10 minute increments after time “A”. Further, each individual interview may have a time limit. Thus, once the time limit has been reached for a particular interview, the particular interview is over and a next interview begins.

In one embodiment, and prior to an initiation of a first interview in the set of online interviews, at 306, server 106 receives login credentials from the user via, for example, computing device 102, and server 106 receives login credentials from a first physician via, for example, one of computing devices 104. These login credentials may be required in order to protect the privacy of everyone involved in the interview process. Thus, each participant may be required to provide credentials (e.g., a username and password) in order to logon to, for example, system 100, that is managing the online interview sessions.

Once login credentials have been verified, and prior to a first interview initiating, at 308, the user may be presented with a bio of the first physician on display 114 of computing device 102. The bio enables the user to review information about the physician prior to conducting an online interview. In one embodiment, the user may not know anything about a physician prior to a bio being. That is, the online interviews may be scheduled such that prior to the interviews, the user does not know the identity of the physicians participating in the online interviews, and the physicians do not know the identity of the user. Thus, the bios provided just prior to an interview may be the first information the user has seen of any of the scheduled physicians. In one embodiment, the bio of the first physician is provided by the first physician. This way, the first physician may present information about himself/herself in the bio that best represents what the first physician would like the user to know. Further, since each interview is scheduled one after the other at predetermined time intervals (e.g., every 10 minutes), to stay on schedule, the user may be provided with a predetermined period of time to review a bio of a physician, for example, two minutes and thirty seconds. The predetermined period of time also provides the user an ability to draft questions he or she wants to ask during the interview regarding the physician's bio.

At 310, an interview session between the user and the first physician is initiated. In one embodiment, a live video of the first user is captured by computing device 102 (e.g., video capture device 116 of computing device 102) and is provided over network 108 and presented to the first physician in real time on display 114 of one of computing devices 104. Simultaneously, a live video of the first physician is captured by one of computing devices 104 (e.g., video capture device 116 of one of computing devices 104) and is provided over network 108 and presented to the user in real time on display 114 of computing device 102. As such, an online, real time, audio video, one on one chat between the user and the first physician is initiated. In one embodiment, each of the videos is shown side by side on respective displays 114. However, one of ordinary skill in the art will appreciate that each video may be presented in a plurality of configurations.

In one embodiment, a timer providing a remaining time available (e.g., 4 minutes and 30 second) and/or an elapsed time (e.g., 30 seconds) is provided to the user and the first physician on respective displays 114. As such, the timer communicates to each of the user and the first physician a continuous count of the time remaining for the interview session. The timer may be provided in any shape, form, or color. For example, as the available time remaining for the interview diminishes and/or the elapsed time of the interview increases, the timer may visually increase in size on each display 114 and/or change colors (e.g., turn from blue to red) to indicate an end of the interview session is drawing closer, for example, one minute remains.

Once the predetermined time for the interview between the user and the first physician has elapsed, at 312, the interview is terminated. In one embodiment, prior to an interview between the user and a second physician is initiated, a default set of survey questions may be provided to the user. These survey questions may pertain to the overall experience of the interview and how it was conducted or may be directed to the physician the user recently interviewed. For example, the survey may request the user to provide initial first impressions regarding the first physician via displays 114. In one embodiment, the physician may also be requested to provide comments regarding the user. As such, the user and the first physician may have a predetermined period of time (e.g., two minutes and thirty seconds) to address all of the survey questions. The default set of survey questions may be displayed to each of the user and the first physician, or may be made available to the user and the first physician through a hyperlink, icon, or other selectable means. In one embodiment, the default set of survey questions may be provided by each of the user and the first physician, a third party, or based on a statistical analysis of one or more users and physicians. For example, based on statistical analysis, a set of common or more often selected set of survey questions may be determined and provided to each of the user and the physician. In one embodiment, a set of survey questions provided to the user may be different than a set of survey questions provided to the first physician. That is, particular questions may be more applicable to a user/patient judging a physician than a physician judging a potential user/patient, and vice versa. Further, the default set of survey questions may be determined based on a dynamically changing set of determined criteria reflecting a set of most often employed criteria, over a time period, for a particular physician practice, gender, or the like.

In one embodiment, a comment addressed by the first physician may be a recommendation by the first physician for the user to interview a particular physician. If the recommended physician is already scheduled to be interviewed by the user, each of the following interviews proceeds accordingly. However, if the recommended physician is not scheduled to be interviewed by the user, one of the physicians scheduled to be interviewed by the user may be replaced by the recommended physician (e.g., if the recommended physician is available). In an alternative embodiment, the recommended physician may be placed on a back-up interview list. Thus, if one of the physicians scheduled to conduct an interview with the user cancels (as described in further detail below), then the recommended physician is used as a first replacement.

Referring back to FIG. 3, once the predetermined time for responding to the survey questions has elapsed, at 314, the user may be presented with a bio of the second physician on display 114 of computing device 102. The user may have a predefined period of time to review the second physician's bio prior to an initiation of the interview between the user and the second physician. In one embodiment, the second physician may conduct the interview from the same computing device 104 that the first physician conducted the previous interview from. For example, each of the first physician and the second physician may be located at a same location and thus each use the same computing device 104. Alternatively, the second physician may conduct the interview from a different one of computing devices 104 that the first physician conducted the previous interview from. Either way, at 316, an interview between the user and the second physician is initiated at a predefined time. In one embodiment, the predefined time may be a lapse in time of the predefined period of time to review the respective bios and/or the predefined period time may be a particular time of day.

While the interview process may run accordingly as long as each participant is available to conduct a scheduled interview, sometimes a person scheduled to conduct an interview during a particular time is not available. For example, in one embodiment, the second physician may not be available to conduct the interview at the scheduled time. Thus, in one embodiment, a separate physician that was not initially scheduled to conduct an interview with the user may be requested to “fill in” for the second physician. For example, a plurality of online interviews may be scheduled to be conducted at the same time with two or more users and a plurality of physicians. Thus, one user may be scheduled to interview a first set of the plurality of physicians, and at the same time, another user may be scheduled to interview a second set of the plurality of physicians. Thus, if a physician from the first set is unable to conduct an interview at a scheduled time, a physician from the second set is provided as a replacement. This way, each of the remaining interviews with the first set of physicians will be conducted at the scheduled times. Further, to enable each of the interviews in the second set to be conducted at the scheduled times, the replacement physician from the second set will not have an interview scheduled for the particular time the replacement physician was chosen to replace.

Further, as mentioned above, the user may not know an identity of a physician prior to the interview until a bio is presented to the user. Thus, in a situation where a physician (e.g., the second physician) is unable to conduct an interview at a scheduled time, replacing the second physician with another physician will be achieved unbeknownst to the user.

In an alternative embodiment, when the second physician is not available to conduct the interview at the scheduled time, a third physician (from the first set of the plurality of physicians) that is scheduled to interview the user after the second physician, replaces the interview time slot of the second physician. Thus, each of the remaining physicians in the first set of the plurality of physicians scheduled to interview the user moves up to an earlier interview time slot. In this embodiment, the last interview time slot, which is now empty, is filled by a separate physician that was not initially scheduled to conduct an interview with the user (e.g., the separate physician in not in the first set or the second set of the plurality of physicians).

In yet another embodiment, when the second physician is not available to conduct the interview at the scheduled time and after each of the remaining physicians in the first set of the plurality of physicians scheduled to interview have interviewed the user and move up to an earlier interview time slot, there may not be a physician from the first set of the plurality of physicians to fill the last time slot for an interview. As such, a physician from the second set of the plurality of physicians is provided as a replacement physician to fill the last time slot for the first set of the plurality of physicians. Thus, to enable each of the interviews in the second set to be conducted at the scheduled times, the physician from the second set of the plurality of physicians that is filling in the last time slot for the first set of the plurality of physicians is required to not have an interview scheduled for that particular time slot in the second set. For example, the physician from the second set that is filling in the last time slot for the first set of the plurality of physicians is required to have already conducted an interview with the other user.

The embodiments described above are provided as illustrative examples of how the system and methods described herein may compensate for any cancellations by an interview participant. For example, five interviews may be scheduled for the user during a particular period of time and five interviews may be scheduled for another user during the same particular period of time. In this example, five physicians may be rotated between the user and the other user. However, in order to compensate for any cancellations, a sixth physician may be provided as a back-up physician and/or included into the rotation to fulfill one of the five time slots for one of the users. Thus, one of ordinary skill in the art will appreciate that in order to compensation for a cancellation while still providing a different physician for each time slot for each user, a minimum number of physicians required is related to a number of users to interview and a number of interviews scheduled for each user.

For example, the minimum number of physicians needed to compensate for a cancellation while still providing a different physician for each time slot for each user can be calculated by Equation 1 shown below, where TS=number of time slots and UGTS=the number of users greater than the number of time slots.

TS+UGTS+1=minimum number of physicians Eq. 1

With reference back to FIG. 3, once the predefined period of time for the interview between the user and the second physician has elapsed, at 318, the interview is terminated. As explained above, in one embodiment, a default set of initial first impression attributes may be displayed to each of the user and the second physician to address once the predetermined time for the interview has elapsed.

At 320, it is determined whether an additional interview for the user is scheduled. If it is determined that an additional interview is not scheduled, then at 326, a final report may be generated. If, at 320, it determined that an additional interview is scheduled, then, at 322, it is determined whether a physician for the scheduled additional interview is available. If, at 322, it is determined that a physician for the scheduled additional interview is available, then the process continues back to step 316. However, if, at 322, it is determined that the physician for the scheduled additional interview is not available, then, at 324, it is determined whether a replacement physician is available. If, at 324, a replacement physician is available, then the process continues back to step 316. However, if it is determined that a replacement physician is not available, then, at 326, a final report may be generated.

In one embodiment, the final report for the user may include an interview score for each physician interviewed. Each interview score may correspond to feedback data (e.g., initial first impression attributes) provided by the user after each interview. In one embodiment, each interview score is automatically calculated by server 106 based on the initial first impression attributes provide by the user. In another embodiment, each interview score is manually provided by the user after each interview or after all the interviews have commenced. In one embodiment, each interview score can be a percentage of the user's feedback within the survey questions that indicate either a superior or an above average rating for initial first impression attributes provided by the user. In another example, each interview score can be a percentage of interviewer feedback within the survey questions that indicate only a superior rating for all attributes.

In another embodiment, if applicable, a compatibility score may be provided in the final report. For example, in a particular embodiment where an interview score of a physician is captured, a compatibility score is generated by server 106 by averaging the interview score of the user with the interview score of a particular physician. Thus, the final report may rank each of the interviews by interview score and by compatibility scores.

In another embodiment, each user of the plurality of users interviewing the plurality of physicians may be family members (e.g., a husband and his wife). That is, a husband and his wife may be interviewing primary care physicians separately in order to provide an unbiased and independent experience with each interview (alternatively, each of the husband and the wife may interview the plurality physicians together, but answer separate survey questions). In this example, in addition to the final report including interview scores and compatibility scores for each of the husband and his wife, the final report may also include a family compatibility score. That is, a family compatibility score may be generated based on the interview scores for each member of the family who interviewed the same physicians. As such, the final report may provide an ability to determine compatibilities between each member of the family and a physician, and compatibilities between an entire family and each physician.

Finally, at 328, an appointment between the user and one of the physicians interviewed by the user is scheduled. In one embodiment, the appointment is automatically scheduled by server 106 based on a generated final report. Alternatively, a user, via display 114 on computing device 102, may be prompted at the end of all of the interviews to schedule an appointment with one of the physicians interviewed by the user. In one embodiment, the prompt on display 114 may be based on the generated final report. In a further embodiment, the prompt may also provide a set of times a particular physician is available for an appointment and enable the user to schedule an appointment at that time. Further, if the physician does not have an available time, the prompt may also enable the user to request a call from the physician's office, such the user is placed on a waiting list, or the user can request the physician to provide a recommendation of another physician that may be available.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for managing a plurality of scheduled online interviews between a user and a plurality of professionals, the method comprising:
initiating a first online interview between the user and a first professional at a first predefined time;
once a first predetermined period of time has elapsed from the first predefined time, terminating the first online interview;
determining if a second professional is available to conduct a second online interview with the user, the second online interview scheduled to be initiated at a second predefined time, the second predefined time being at an end of the first predefined period of time that elapsed from the first predefined time;
based on a determining that the second professional is not available to conduct the second online interview with the user, replacing the second professional with a third professional that is available to conduct the second online interview with the user at the second predefined time; and
initiating the second online interview between the user and the third professional at the second predefined time.

2. A method in accordance with claim 1, further comprising:
prior to initiating the first online interview between the user and the first professional at the first predefined time:
scheduling the first online interview between the user and the first professional to initiate at the first predefined time;
scheduling the second online interview between the user and the second professional to initiate at the second predefined time; and
scheduling a third online interview between the user and the third professional to initiate at a third predefined time.

3. A method in accordance with claim 2, further comprising:
once a second predetermined period of time has elapsed from the second predefined time, terminating the second online interview; and
based on replacing the second professional with the third professional to conduct the second online interview with the user at the second predefined time, replacing the third professional with a fourth professional and initiating the third online interview between the user and the fourth professional at the third predefined time, the third predefined time being an end of the second predefined period of time that elapsed from the second predefined time.

4. A method in accordance with claim 3, further comprising:
receiving, from the first professional, a response to the first online interview, the response comprising a recommendation to schedule an interview between the user and the fourth professional; and
based on the recommendation, initiating the third online interview between the user and the fourth professional at the third predefined time.

5. A method in accordance with claim 4, wherein the fourth professional was not scheduled to conduct an interview with the user prior to the recommendation.

6. A method in accordance with claim 1, further comprising generating a report of each of the first online interview and the second online interview, the report comprising a compatibility rating between the user and the first professional and a compatibility rating between the user and the second professional.

7. A method in accordance with claim 6, wherein the compatibility rating between the user and the first professional is based on a rating of the first interview provided by the user and a rating of the first interview provided by the first professional, and
wherein the compatibility rating between the user and the second professional is based on a rating of the second interview provided by the user and a rating of the second interview provided by the second professional.

8. A method for managing a plurality of scheduled online interviews between a plurality of users and a plurality of professionals, the method comprising:
initiating a first online interview between a first user and a first professional at a first predefined time;
initiating a second online interview between a second user and a second professional at the first predefined time;
once a first predetermined period of time has elapsed from the first predefined time, terminating the first online interview and the second online interview;
initiating a third online interview between the first user and the second professional at a second predefined time;
initiating a fourth online interview between the second user and the first professional at the second predefined time, the second predefined time being at an end of the first predefined period of time that elapsed from the first predefined time; and
generating a report based on the first online interview, the second online interview, the third online interview, and the fourth online interview.

9. A method in accordance with claim 8, wherein each of the first professional and the second professional are physicians.

10. A method in accordance with claim 8, wherein the generated report includes a compatibility of the first user with the first professional and the second professional, and a compatibility of the second user with the first professional and the second professional.

11. A method in accordance with claim 10, wherein the generated report further includes a combined compatibility of the first user and the second user with the first professional and a combined compatibility of the first user and the second user with the second professional.

12. A method in accordance with claim 11, wherein the first user and the second user are family members.

13. A method in accordance with claim 8, further comprising:
receiving, from the first professional, a response to the first online interview and the fourth online interview, the response comprising a recommendation to schedule an interview between each of the first user and the second user with a third professional; and
based on the recommendation, scheduling a fifth online interview between the first user and the third professional and a sixth online interview between the second user and the third professional.

14. One or more non-transitory computer-readable media having computer-executable instructions embodied thereon, wherein when executed by at least one processor, the computer-executable instructions cause the processor to:
initiate a first online interview between a user and a first professional at a first predefined time;
once a first predetermined period of time has elapsed from the first predefined time, terminate the first online interview;
determine if a second professional is available to conduct a second online interview with the user, the second online interview scheduled to be initiated at a second predefined time, the second predefined time being at an end of the first predefined period of time that elapsed from the first predefined time;
based on the determining that the second professional is not available to conduct the second online interview with the user, replace the second professional with a third professional that is available to conduct the second online interview with the user at the second predefined time; and
initiate the second online interview between the user and the third professional at the second predefined time.

15. One or more non-transitory computer-readable media in accordance with claim 14, wherein prior to initiating the first online interview between the user and the first professional at the first predefined time, wherein the computer-executable instructions further cause the processor to:
schedule the first online interview between the user and the first professional to initiate at the first predefined time;
schedule the second online interview between the user and the second professional to initiate at the second predefined time; and
schedule a third online interview between the user and the third professional to initiate at a third predefined time.

16. One or more non-transitory computer-readable media in accordance with claim 15, wherein once a second predetermined period of time has elapsed from the second predefined time, wherein the computer-executable instructions further cause the processor to:
terminate the second online interview; and
based on replacing the second professional with the third professional to conduct the second online interview with the user at the second predefined time, replace the third professional with a fourth professional and initiating the third online interview between the user and the fourth professional at the third predefined time, the third predefined time being an end of the second predefined period of time that elapsed from the second predefined time.

17. One or more non-transitory computer-readable media in accordance with claim 16, wherein the computer-executable instructions further cause the processor to:
receive, from the first professional, a response to the first online interview, the response comprising a recommendation to schedule an interview between the user and the fourth professional; and
based on the recommendation, initiate the third online interview between the user and the fourth professional at the third predefined time.

18. One or more non-transitory computer-readable media in accordance with claim 17, wherein the fourth professional was not scheduled to conduct an interview with the user prior to the recommendation.

19. One or more non-transitory computer-readable media in accordance with claim 15, wherein the computer-executable instructions further cause the processor to generate a report of each of the first online interview and the second online interview, the report comprising a compatibility rating between the user and the first professional and a compatibility rating between the user and the second professional.

20. One or more non-transitory computer-readable media in accordance with claim 19, wherein the compatibility rating between the user and the first professional is based on a rating of the first interview provided by the user and a rating of the first interview provided by the first professional; and
wherein the compatibility rating between the user and the third professional is based on a rating of the second interview provided by the user and a rating of the second interview provided by the third professional.
